(19) United States
(12) Patent Application Publication
(10) Pub. No.: US 2017/0277339 A1
(43) Pub. Date: Sep. 28, 2017

(54) UNLOCKING METHOD FOR TERMINAL AND TERMINAL

(71) Applicants: Le Holdings (Beijing) Co., Ltd., Beijing (CN); Lemobile Information Technology (Beijing) Co., Ltd., Beijing (CN)

(72) Inventor: Haosen Suo, Beijing (CN)

(21) Appl. No.: 15/335,411

(22) Filed: Oct. 26, 2016

Related U.S. Application Data
(63) Continuation of application No. PCT/CN2016/096427, filed on Aug. 23, 2016.

(30) Foreign Application Priority Data
Mar. 25, 2016 (CN) 201610180470X

(51) Int. Cl. G06F 3/041; G06F 3/0488; G06F 3/044

(52) U.S. Cl. CPC G06F 3/0416; G06F 3/044; G06F 3/04886; G06F 2203/04105

(57) ABSTRACT

Embodiments of the present disclosure provide an unlocking method for a terminal and the terminal. The unlocking method for the terminal provided by the embodiments of the present disclosure comprises: acquiring operation information of a user at edge touch areas of the terminal in a screen locking state; and unlocking the terminal according to the operation information of the user at the edge touch areas of the terminal. The technical solutions according to the embodiments of the present disclosure solve the problem of relatively high unlocking operation cost in the prior art, reduce the unlocking time, and improve the unlocking efficiency.

### CROSS REFERENCE TO RELATED APPLICATIONS

The present disclosure is a continuation of international application No. PCT/CN2016/096427, filed on 23 Aug. 2016 which is based upon and claims the priority of Chinese Patent Application No. 201610180470X, on Mar. 25, 2016, and entitled “UNLOCKING METHOD FOR TERMINAL AND TERMINAL”, the entire contents of which are incorporated herein by reference.

### TECHNICAL FIELD

The present disclosure relates to the technical field of communications, and particularly relates to an unlocking method for a terminal and the terminal.

### BACKGROUND

With the development of science and the progress of technology, intelligent terminals have become increasingly popular. In order to improve the use efficiency and enhance good user experience, the existing intelligent terminals mostly interact with users by adopting touch screens.

In order that users obtain good visual effect, the screens of the terminals are generally large, and their power consumption is also high. Thus, a screen locking function can be set in a terminal to save power without closing system software. After a user executes screen locking operation, he can enter the system again in a certain unlocking mode.

In the process of product research and development, the inventor discovers that the prior art at least has the following problems: the terminal is mostly unlocked in the mode of swiping unlocking, password unlocking or the like, and it takes a user some time to unlock the terminal in any unlocking mode, so that the unlocking operation cost is relatively high and the unlocking efficiency is relatively low.

### SUMMARY

In view of this, various embodiments of the present disclosure provide an unlocking method for a terminal and the terminal for solving the problems of relatively high unlocking operation cost and relatively low unlocking efficiency existed in the prior art.

To fulfill the above inventive object, in one aspect, an embodiment of the present disclosure provides an unlocking method for a terminal, adapted to be used by a server, said method including: acquiring operation information of a user at edge touch areas of the terminal in a screen locking state; and unlocking the terminal according to the operation information of the user at the edge touch areas of the terminal.

In another aspect, an embodiment of the present disclosure provides a terminal, including: an acquisition module, used for acquiring operation information of a user at edge touch areas of the terminal in a screen locking state; and a control module, used for unlocking the terminal according to the operation information of the user at the edge touch areas of the terminal.

In a further aspect, an embodiment of the present disclosure provides a terminal, including at least one processor and a memory in communication connection with the at least one processor, wherein the memory stores instructions executable by the at least one processor, and the instructions are executed by the at least one processor, so that the at least one processor can acquire operation information of a user at edge touch areas of the terminal in a screen locking state; and unlock the terminal according to the operation information of the user at the edge touch areas of the terminal.

In a further aspect, an embodiment of the present disclosure provides a non-transient computer readable storage medium, which stores computer executable instructions, the computer executable instructions are used for: acquiring operation information of a user at edge touch areas of the terminal in a screen locking state; and unlocking the terminal according to the operation information of the user at the edge touch areas of the terminal.

### BRIEF DESCRIPTION OF DRAWINGS

One or more embodiments are illustrated by way of example via figures in corresponding drawings, these illustrations do not limit the embodiments, components with the same reference numerical signs in the drawings represent similar elements, and the figures in the drawings do not have proportional limitations unless otherwise specified.

FIG. 1 is a flow diagram of embodiment 1 of an unlocking method for a terminal provided by an embodiment of the present disclosure;

FIG. 2 is a flow diagram of embodiment 2 of an unlocking method for a terminal provided by an embodiment of the present disclosure;

FIG. 3 is a structural schematic diagram of a terminal provided by an embodiment of the present disclosure;

FIG. 4 is a schematic diagram of a hardware structure of a terminal for executing the unlocking method for the terminal provided by an embodiment of the present disclosure.

### DETAILED DESCRIPTION

Preferred embodiments of the present disclosure will be illustrated below in combination with the accompanying drawings. It should be understood that the preferred embodiments described herein are merely used for illustrating and interpreting the present disclosure, rather than limiting the present disclosure.

It should be clear that the described embodiments are merely part of, not all of the embodiments of the present disclosure. Based on the embodiments in the present disclosure, all other embodiments obtained by those of ordinary skill in the art without any creative effort shall be within the protection scope of the present disclosure.

The terms used in the embodiments of the present disclosure are for describing specific embodiments only, rather than limiting the present disclosure. Singular forms “one”, “said” and “the” used in the embodiments and the appended claims of the present disclosure also intend to include plural forms, unless the context clearly expresses other meanings.

Upon the context, the word “if” used herein can be interpreted as “at the time of . . . ” or “when . . . ” or “responding to determining” or “responding to detecting”. Similarly, upon the context, the phrase “if determining” or “if detecting (the stated condition or event)” can be interpreted as “when determining” or “responding to determining” or “when detecting (the stated condition or event)” or “responding to detecting (the stated condition or event)”.

### Embodiment 1

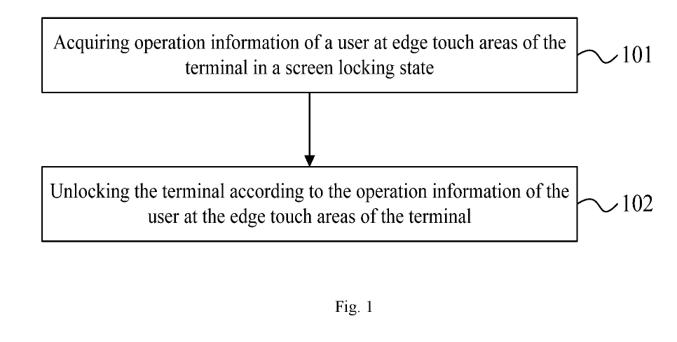

FIG. 1 is a flow diagram of embodiment 1 of an unlocking method for a terminal provided by an embodiment of the present disclosure. As shown in FIG. 1, the unlocking method for the terminal in the embodiment may specifically include steps 101˜102.

101, acquiring operation information of a user that is generated when the user operates at edge touch areas of the terminal in a screen locking state.

In order to improve good interaction experience between a terminal and a user and enable the user to obtain good visual effect, the screen of the terminal is increasingly large. Because the screen of the terminal is enlarged, the corresponding power consumption is also increased, a screen locking function is thus designed in order to improve the battery life of the terminal. A user can lock the screen via a power button, or the terminal automatically enters a screen locking state in the case where the user does not carry out any operation on the terminal for a certain period of time. After the screen of the terminal is locked, the screen is turned off, so that the purpose of improving the endurance of the terminal is fulfilled.

Unlocking operation then is needed when the user wants to use the terminal after the screen of the terminal is locked. The unlocking modes are diverse, generally, a password unlocking page appears after the power button is pressed, or a swiping unlocking page appears after a home page key is pressed, etc. Said unlocking modes need the user to carry out a series of operations on the page of the terminal, and if the user forgets the password or inputs a wrong password, the user cannot enter the terminal, so certain inconvenience is brought to the user.

Thus, the embodiment of the present disclosure provides a scheme, which intends to provide a convenient and quick mode of unlocking the terminal to achieve the effect of improving the unlocking efficiency.

In the embodiment of the present disclosure, operation information of a user at edge touch areas of the terminal in a screen locking state is acquired.

It should be noted that the terminal involved in the embodiment of the present disclosure may include but not limited to a personal computer (PC), a personal digital assistant (PDA), a wireless handheld device, a tablet computer, a mobile phone, an MP3 player, an MP4 player, etc., and the terminal has a screen.

In the embodiment of the present disclosure, the operation information of the user at the edge touch areas of the terminal may include but not limited to operation information generated after pressing operation of the user at the edge touch areas of the terminal.

It could be understood that edge touch refers to providing touch input via the edge, the border or the back of the terminal to track clicking, swiping or pressing operation of a finger on the edge of the terminal so as to control the terminal.

The edge touch areas of the terminal may be the ones that the thumb of the user can reach on the sides of the terminal when the user naturally holds the terminal, and the sides of the terminal may include other four sides except the front side and the back side.

In the embodiment of the present disclosure, the edge touch areas of the terminal may be realized by physical keys, virtual keys, sensors or a screen.

For example, if the terminal uses a curved screen, the edge touch areas of the terminal can be realized by the edge screen of the curved screen. Taking a capacitive touch screen as an example for illustration, when the fingers of the user touch the edge touch screen, the capacitance of touch spots will be changed, so that the frequency of an oscillator connected with a capacitor is changed, the touch positions can be determined by measuring the change of the frequency of the oscillator, and then the operation information of the user at the edge touch areas of the terminal can be acquired.

As another example, if physical keys for adjusting the volume are at the edge of the terminal, taking the physical keys for adjusting the volume in the terminal as an example for illustration, when the finger of the user presses a physical key for adjusting the volume, the terminal may learn which key the user presses, the key for turning up the volume or the key for turning down the volume. Similarly, if the user carries out pressing operation at the edge touch areas, the operation information of the user at the edge touch areas of the terminal can be acquired.

As another example, if virtual keys with certain functions are at the edges of the terminal and when the virtual keys are capacitive virtual keys, the terminal judges which virtual key the user touches via the capacitance of the capacitive virtual keys. Specifically, the finger and the electrode plate in a capacitive virtual key may form a capacitor when the user touches the capacitive virtual key, the terminal determines the touch position of the user by detecting the change of the capacitance so as to determine which virtual key the user touches, and then the operation information of the user at the edge touch areas of the terminal can be acquired.

As another example, if sensors with certain functions are at the edges of the terminal, taking the sensors which are pressure sensors on the terminal as an example, when the user presses a pressure sensor, semiconductor deformation pressure is formed on the flaky surface of the pressure sensor, the flaky surface is deformed by pressing to produce a piezoelectric impedance effect, the change of the impedance is converted into an electrical signal, and after acquiring the electrical signal, the terminal can determine which pressure sensor the user presses or which position on the pressure sensor the user presses so as to determine which function of the pressure sensor the user presses, and then acquire the operation information of the user at the edge touch areas of the terminal. In addition, the sensors with certain functions at the edge of the terminal may also be photo sensors.

In the embodiment of the present disclosure, the number of the edge touch areas of the terminal is an even number, and the even edge touch areas are arranged oppositely. For example, the edge touch areas may be set on the left and right sides of the terminal, or the upper and lower sides of the terminal, or the upper, lower, left and right sides.

102, unlocking the terminal according to the operation information of the user at the edge touch areas of the terminal.

The user unlocks the terminal via the edge touch areas of the terminal in one of multiple unlocking modes of the terminal, and the function of unlocking with the edge touch areas can be previously opened in the functional setting of the terminal.

Pressing operation information is acquired according to the pressing operation of the user at the edge touch areas of the terminal. In this embodiment, the edge touch areas are set on two opposite sides of the terminal. Then, when the two opposite sides acquire the pressing operation information, it can be regarded as the user holds the terminal in hands and is carrying out unlocking operation, and the terminal is unlocked.

For example, if the terminal uses a curved screen, the edge touch areas of the terminal can be realized by the edge screen of the curved screen. Taking a capacitive touch screen as an example, when the user holding the edge touch areas on the left and right sides of the terminal carries out pressing operation, the operation information of the user at the edge touch areas of the terminal can be acquired, then the terminal is unlocked, and the screen of the terminal is lightened after the unlocking succeeds.

If a physical key is at each of the left side and the right side of the terminal, when the user holds the terminal and simultaneously presses the physical keys on the left side and the right side, the operation information of the user at the edge touch areas of the terminal can be acquired, then the terminal is unlocked, and the screen of the terminal is lightened after the unlocking succeeds.

If virtual keys with certain functions are arranged on the upper and lower sides of the terminal and the virtual keys are capacitive virtual keys, when the fingers of the user simultaneously press the virtual keys on the upper and lower sides of the terminal, the operation information of the user at the edge touch areas of the terminal can be acquired, then the terminal is unlocked, and the screen of the terminal is lightened after the unlocking succeeds.

According to the unlocking method for the terminal provided by the embodiment of the present disclosure, operation information of a user at edge touch areas of the terminal in a screen locking state is acquired, and the terminal is unlocked according to the operation information of the user at the edge touch areas of the terminal. The embodiment of the present disclosure adopts the mode of unlocking the terminal at the edge touch areas of the terminal, thereby solving the problems of relatively high unlocking operation cost and relatively low unlocking efficiency caused by a reason that the unlocking modes in the prior art take some time to realize unlocking, realizing quick and effective identification of the operation information of the user for unlocking the terminal, reducing the unlocking time, improving the unlocking efficiency and lowering the unlocking operation cost.

### Embodiment 2

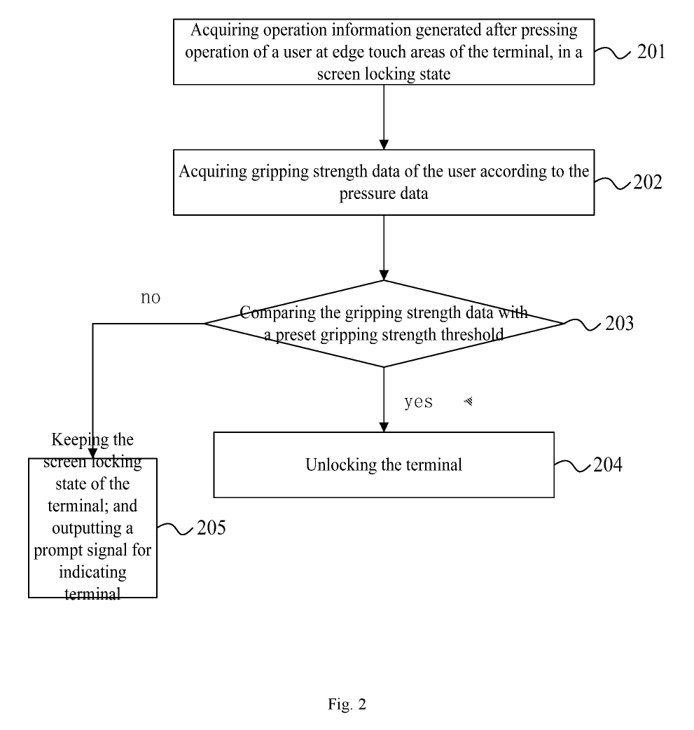

FIG. 2 is a flow diagram of embodiment 2 of an unlocking method for a terminal provided by an embodiment of the present disclosure. As shown in FIG. 2, the unlocking method for the terminal in this embodiment may specifically include steps 201˜205.

201, acquiring operation information generated after pressing operation of a user at edge touch areas of the terminal in a screen locking state.

For the process of acquiring operation information generated after pressing operation of a user at edge touch areas of the terminal in a screen locking state, reference is made to the description in step 101 of the above embodiment for details, and its principle and implementation process in this embodiment are the same as those in the above embodiment and are thus not redundantly described herein.

It should be noted that the operation information generated after pressing operation of the user at the edge touch areas of the terminal is pressure data in this embodiment.

202, acquiring gripping strength data of the user according to the pressure data.

The pressure data is acquired by pressure sensors arranged in the edge touch areas of the terminal, and the pressure data is generated by pressing the edge touch areas of the terminal when the user holds the terminal.

When the user holds the terminal, the edge touch areas of the terminal are pressed, different electrical signals are generated via the change of hand pressure area, then the pressure sensors carry out processing and transmit the electrical signals to a processing module of the terminal, and the processing module carries out conversion according to a conversion formula between the pressure and the gripping strength to obtain a gripping strength value, that is, the gripping strength data.

For example, the user holds the edge touch areas of the left and right sides of the terminal and applies certain pressure to the edge touch areas of the terminal, the terminal acquires pressure data of the user, and gripping strength data 1 KG of the user is obtained by conversion of the processing module in the terminal.

203, comparing the gripping strength data with a preset gripping strength threshold. If the gripping strength data is greater than or equal to the gripping strength threshold, executing step 204; and if the gripping strength data is smaller than the gripping strength threshold, executing step 205.

When the user uses the terminal, pressing operation of different strengths is applied to the terminal due to different use states. Thus, in order to distinguish whether the user normally holds the terminal or carries out the unlocking operation, a gripping strength threshold can be preset in the terminal. When the user carries out pressing operation on the edge touch areas of the terminal, gripping strength data of the user can be acquired according to the pressure data, and then the gripping strength data is compared with the preset gripping strength threshold.

The preset gripping strength threshold may be pressure data generated by pressing operation at the edge touch areas of the terminal before the user opens a gripping strength unlocking function, and the terminal acquires gripping strength data according to the pressure data and stores the data therein. The gripping strength threshold may be gripping strength data recorded once, or an average value of gripping strength data recorded for many times.

When the gripping strength data is greater than or equal to the gripping strength threshold, it can be regarded as the user unlocks the terminal, and step 204 is executed.

When the gripping strength data is smaller than the gripping strength threshold, it can be regarded as the user normally holds the terminal or mistakenly touches the edge touch areas of the terminal, and step 205 is executed.

204, unlocking the terminal.

After the user holds the terminal and unlocks the terminal, either the state before the screen locking or the desktop of the terminal can be displayed in the screen of the terminal.

205, keeping the screen locking state of the terminal, and outputting a prompt signal for indicating terminal unlocking failure.

After the user holds the terminal and fails in unlocking the terminal, the terminal is kept in the screen locking state, and prompt information of terminal unlocking failure is output to the user.

For example, output of the prompt signal for indicating terminal unlocking failure may be implemented in a terminal vibration, prompt tone, prompt information or other mode, and the embodiment of the present disclosure is not specially limited thereto.

According to the unlocking method for the terminal provided by the embodiment of the present disclosure, operation information of a user at edge touch areas of the terminal in a screen locking state is acquired, corresponding pressure data is acquired according to the operation information of the user at the edge touch areas of the terminal, gripping strength data is acquired according to the pressure data and compared with a preset gripping strength threshold in the terminal, the terminal is unlocked or the screen locking state is protected, thereby solving the problems of relatively high unlocking operation cost and relatively low unlocking efficiency caused by a reason that the unlocking modes in the prior art take some time to realize unlocking, realizing quick and effective identification of the operation information of the user for unlocking the terminal, reducing the unlocking time, improving the unlocking efficiency and lowering the unlocking operation cost.

The present disclosure further provides a device embodiment for implementing the steps and the methods in the above method embodiment.

### Embodiment 3

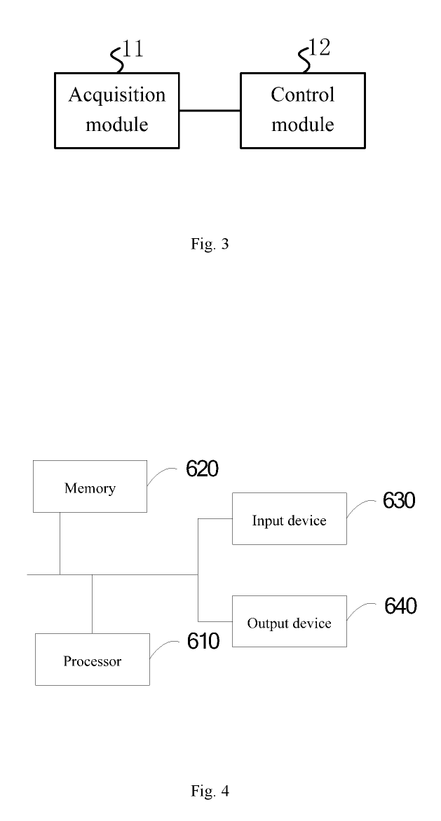

FIG. 3 is a structural schematic diagram of a terminal provided by an embodiment of the present disclosure. As shown in FIG. 3, the terminal provided by the embodiment of the present disclosure includes an acquisition module 11 and a control module 12.

The acquisition module 11 is used for acquiring operation information of a user at edge touch areas of the terminal in a screen locking state.

The control module 12 is used for unlocking the terminal according to the operation information, acquired by the acquisition module 11, of the user at the edge touch areas of the terminal.

The operation information of the user at the edge touch areas of the terminal includes operation information generated after pressing operation of the user at the edge touch areas of the terminal.

It should be noted that the edge touch areas of the terminal in this embodiment are even-numbered, and the even edge touch areas are arranged oppositely.

Specifically, the operation information generated after pressing operation of the user at the edge touch areas of the terminal is pressure data; and according to the pressing operation of the user at the edge touch areas of the terminal, the control module 12 is specifically used for: acquiring gripping strength data of the user according to the pressure data, comparing the gripping strength data with a preset gripping strength threshold, and unlocking the terminal if the gripping strength data is greater than or equal to the gripping strength threshold.

The control module 12 is further used for: if the gripping strength data is smaller than the gripping strength threshold, keeping the screen locking state of the terminal; and the terminal further includes an output module, used for outputting a prompt signal for indicating terminal unlocking failure.

The terminal of the embodiment of the present disclosure can be used for executing the technical solution of the method embodiment shown in FIG. 1 or FIG. 2, and its implementation principle and technical effects are similar to those in the above embodiment and are thus not redundantly described herein.

According to the terminal of the present disclosure, an acquisition module 11 acquires operation information of a user at edge touch areas of the terminal in a screen locking state, and a control module 12 unlocks the terminal according to the acquired operation information. The embodiment of the present disclosure adopts the mode of unlocking the terminal at the edge touch areas of the terminal, thereby solving the problems of relatively high unlocking operation cost and relatively low unlocking efficiency caused by a reason that the unlocking modes in the prior art take some time to realize unlocking, realizing quick and effective identification of the operation information of the user for unlocking the terminal, reducing the unlocking time, improving the unlocking efficiency and lowering the unlocking operation cost.

### Embodiment 4

An embodiment of the present disclosure provides a non-volatile computer storage medium, the computer storage medium stores computer executable instructions, and the computer executable instructions can execute the processing method in any above method embodiment.

### Embodiment 5

FIG. 4 is a schematic diagram of a hardware structure of a terminal for executing the unlocking method for the terminal provided by an embodiment of the present disclosure. As shown in FIG. 4, the terminal includes one or more processors 610 and a memory 620. One processor 610 is taken as an example in FIG. 4. The terminal may further include an input device 630 and an output device 640.

The processor 610, the memory 620, the input device 630 and the output device 640 can be connected via a bus or in other mode, taking bus connection as an example in FIG. 4.

The memory 620 serving as a non-volatile computer readable storage medium can be used for storing non-volatile software programs, non-volatile computer executable programs and modules. The processor 610 runs the non-volatile software programs, instructions and modules stored in the memory 620 to execute various functional disclosures and data processing of the terminal, i.e., to implement the processing method in the above method embodiments.

The memory 620 may include a program storage area and a data storage area, wherein the program storage area can store an operating system and an disclosure program required by at least one function; and the data storage area can store data and the like. Moreover, the memory 620 may include a high-speed random access memory, and may also include a non-volatile memory, e.g., at least one disk storage device, a flash device or other non-volatile solid-state storage device. In some embodiments, the memory 620 may include memories arranged remotely relative to the processor 610, and these remote memories can be connected to the processor via a network. The example of the network includes but not limited to the internet, an intranet, a local area network, a mobile communication network and a combination thereof.

The input device 630 can receive input digital or character information and generate signal input. The output device 640 may include display equipment such as a display screen.

The one or more modules are stored in the memory 620, and are executed by the one or more processors 610 to execute: acquiring operation information of a user at edge touch areas of the terminal in a screen locking state; and unlocking the terminal according to the operation information of the user at the edge touch areas of the terminal.

In a possible implementation way, the operation information of the user at the edge touch areas of the terminal includes operation information generated after pressing operation of the user at the edge touch areas of the terminal.

In a possible implementation way, the edge touch areas of the terminal are even-numbered, and the even edge touch areas are arranged oppositely.

In a possible implementation way, the operation information generated after pressing operation of the user at the edge touch areas of the terminal is pressure data; and the unlocking the terminal according to the operation information of the user at the edge touch areas of the terminal includes: acquiring gripping strength data of the user according to the pressure data, comparing the gripping strength data with a preset gripping strength threshold, and unlocking the terminal if the gripping strength data is greater than or equal to the gripping strength threshold.

In a possible implementation way, the method further includes: if the gripping strength data is smaller than the gripping strength threshold, keeping the screen locking state of the terminal; and outputting a prompt signal for indicating terminal unlocking failure.

The above product can execute the methods provided by the embodiments of the present disclosure, and has corresponding functional modules for executing the methods and corresponding advantages. For the technical details not described in detail in this embodiment, reference may be made to the methods provided by the embodiments of the present disclosure.

The terminal in the embodiments of the present disclosure exists in multiple forms, including but not limited to: Mobile communication equipment: this type of equipment is characterized by a mobile communication function, and has main goals of providing voice and data communication. The terminal includes a smart phone (e.g., iPhone), a multimedia phone, a functional phone, a low-end phone, etc.

Ultra-mobile personal computer equipment: this type of equipment belongs to the scope of personal computers, has computing and processing functions, and generally also has mobile internet characteristic. The terminal includes PAD, an MID (Mobile Internet Device) and UMPC (Ultra Mobile Personal Computer) equipment and the like, e.g., iPad.

Portable entertainment equipment: this type of equipment can display and play multimedia contents. The equipment includes audio and video players (e.g., iPod), a handheld game player, an electronic book, an intelligent toy and portable vehicle-mounted navigation equipment.

Server: equipment for providing computing services, including a processor, a hard disk, a memory, a system bus, etc., wherein the architecture of the server is similar to that of a general computer, but the server is highly required on the aspects of processing capability, stability, reliability, security, expandability, manageability and the like because it needs to provide highly reliable services.

Other electronic devices with a data interaction function.

The above-described device embodiments are only schematic, wherein the units illustrated as separate components may be or may not be physically separated, and the components displayed as units may be or may not be physical units, that is to say, the components may be positioned at one place or may also be distributed on a plurality of network units. The objectives of the solutions of the embodiments may be fulfilled by selecting part of or all of the modules according to actual needs.

Upon the descriptions of the above embodiments, those skilled in the art can clearly learn that each embodiment can be realized by means of software and a general hardware platform, and of course, can be realized via hardware. Based on such an understanding, the above technical solutions substantially or the parts making contribution to relevant technologies may be embodied in the form of a software product, and the computer software product can be stored in a computer readable storage medium, such as an ROM (Read-Only Memory)/RAM (Random Access Memory), a magnetic disk, an optical disk, etc., which includes a plurality of instructions enabling computer equipment (which may be a personal computer, a server, or network equipment or the like) to execute each embodiment or the method in some part of each embodiment.

Finally, it should be noted that the above embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to a part of technical features thereof; and these modifications or substitutions do not make the essence of the corresponding technical solutions depart from the spirit and scope of the technical solutions of the respective embodiments of the present disclosure.

### INDUSTRIAL APPLICABILITY

According to the unlocking method for the terminal and the terminal provided by the embodiments of the present disclosure, operation information of a user at edge touch areas of the terminal in a screen locking state is acquired; and

The terminal is unlocked according to the operation information of the user at the edge touch areas of the terminal, thereby realizing quick and effective identification of the operation information of the user for unlocking the terminal, reducing the unlocking time, improving the unlocking efficiency and lowering the unlocking operation cost.

1. An unlocking method for a terminal, adapted to be used by a server, said method comprising:
acquiring operation information of a user at edge touch areas of the terminal in a screen locking state; and
unlocking the terminal according to the operation information of the user at the edge touch areas of the terminal.

2. The method of claim 1, wherein the operation information of the user at the edge touch areas of the terminal comprises:
operation information generated after pressing operation of the user at the edge touch areas of the terminal.

3. The method of claim 2, wherein the number of the edge touch areas of the terminal is an even number, and the even edge touch areas are arranged oppositely.

4. The method of claim 2, wherein the operation information generated after pressing operation of the user at the edge touch areas of the terminal is pressure data;
the unlocking the terminal according to the operation information of the user at the edge touch areas of the terminal comprises:
acquiring gripping strength data of the user according to the pressure data;
comparing the gripping strength data with a preset gripping strength threshold, and unlocking the terminal if the gripping strength data is greater than or equal to the gripping strength threshold.

5. The method of claim 4, further comprising:
if the gripping strength data is smaller than the gripping strength threshold, keeping the screen locking state of the terminal; and
outputting a prompt signal for indicating terminal unlocking failure.

6. A terminal, comprising:
at least one processor; and
a memory in communication connection with the at least one processor, wherein
the memory stores instructions executable by the at least one processor, and the instructions are executed by the at least one processor, so that the at least one processor can:
acquire operation information of a user at edge touch areas of the terminal in a screen locking state; and
unlock the terminal according to the operation information of the user at the edge touch areas of the terminal.

7. The terminal of claim 6, wherein the operation information of the user at the edge touch areas of the terminal comprises:
operation information generated after pressing operation of the user at the edge touch areas of the terminal.

8. The terminal of claim 7, wherein the number of the edge touch areas of the terminal is an even number, and the even edge touch areas are arranged oppositely.

9. The terminal of claim 7, wherein the operation information generated after pressing operation of the user at the edge touch areas of the terminal is pressure data;
the unlocking the terminal according to the operation information of the user at the edge touch areas of the terminal comprises:
acquiring gripping strength data of the user according to the pressure data;
comparing the gripping strength data with a preset gripping strength threshold, and unlocking the terminal if the gripping strength data is greater than or equal to the gripping strength threshold.

10. The terminal of claim 9, wherein the method further comprises:
if the gripping strength data is smaller than the gripping strength threshold, keeping the screen locking state of the terminal; and
outputting a prompt signal for indicating terminal unlocking failure.

11. A non-transient computer readable storage medium, wherein the non-transient computer readable storage medium stores computer executable instructions, which are used for: acquiring operation information of a user at edge touch areas of the terminal in a screen locking state; and
unlocking the terminal according to the operation information of the user at the edge touch areas of the terminal.

12. The non-transient computer readable storage medium of claim 11, wherein the operation information of the user at the edge touch areas of the terminal comprises:
operation information generated after pressing operation of the user at the edge touch areas of the terminal.

13. The non-transient computer readable storage medium of claim 12, wherein the edge touch areas of the terminal are even, and the even edge touch areas are arranged oppositely.

14. The non-transient computer readable storage medium of claim 12, wherein the operation information generated after pressing operation of the user at the edge touch areas of the terminal is pressure data;
the unlocking the terminal according to the operation information of the user at the edge touch areas of the terminal comprises:
acquiring gripping strength data of the user according to the pressure data;
comparing the gripping strength data with a preset gripping strength threshold, and unlocking the terminal if the gripping strength data is greater than or equal to the gripping strength threshold.

15. The non-transient computer readable storage medium of claim 14, wherein the method further comprises:
if the gripping strength data is smaller than the gripping strength threshold, keeping the screen locking state of the terminal; and
outputting a prompt signal for indicating terminal unlocking failure.
